(19) United States
(12) Patent Application Publication
(10) Pub. No.: US 2003/0038878 A1
(43) Pub. Date: Feb. 27, 2003

(54) Remotely initiated surveillance

(76) Inventors: Chinmei Chen Lee, Woodridge, IL (US); Douglas William Varney, Naperville, IL (US)

Correspondence Address: Docket Administrator (Room 3J-219), Lucent Technologies Inc., 101 Crawfords Corner Road, Holmdel, NJ, 07733-3030, US

(21) Appl. No.: 09/933,655

(22) Filed: Aug. 21, 2001

(51) Int. Cl. H04N 7/18

(52) U.S. Cl. 348/143; 348/116; 342/357.06; 342/357.12

(57) ABSTRACT

In the method disclosed, a mobile terminal subscriber can seize control of and direct surveillance equipment to focus in on an identified area. The mobile terminal subscriber initiates the surveillance process by selecting a “surveillance” option from a menu, or by entering a code. The area placed under surveillance is the location of the subscriber's mobile terminal or a remote area identified by the subscriber. Where the area under surveillance is the location of the mobile terminal, the area can be identified by using location technology such as global satellite positioning signals or signals generated by the wireless network to obtain the coordinates of the mobile terminal. Knowing the coordinates of the area that is designated to be under surveillance and the location of the surveillance equipment (e.g., latitude, longitude and altitude), the selection and orientation of the selected surveillance equipment, i. e., video surveillance camera located proximate the area can be oriented to focus in on the area. If desired, the subscriber can talk to an attendant observing the activity on a video consul. The area can remain under surveillance for a set time period or until terminated by the mobile terminal subscriber or the attendant. The activity under surveillance can be identified and recorded when conditions suggest that it is appropriate to do so.

### BACKGROUND OF THE INVENTION

1. Field of the Invention

This invention relates to a method of initiating surveillance of an area or event.

2. Description of the Related Art

Remotely controlled video cameras are widely used for surveillance purposes in stores, banks, parking lots, buildings, train stations, street intersections, highways and other areas too numerous to mention. Video cameras are typically mounted on a pan/tilt head designed to rotate about a vertical axis for panning as well as about a horizontal axis for tilting. Typically, a pan/tilt head is normally mounted to a wall or roof of a building or to a pole and is motorized with a separate motor for each of the motions. The motors are typically hard wired to a control at a fixed location and can be operated continuously, intermittently or for set time periods to provide routine scanning or can be operated by an attendant. Normally, when operated by an attendant, the video camera control is at a remote location and the attendant manually orients the video camera by means of a hard wired control while observing a monitor. While current systems provide a degree of controlled surveillance, they do have their inherent disadvantages.

More specifically, with a system that relies upon rigidly mounted fixed video cameras, an attendant can only view a specific area. An example of this type of system is where the video camera is positioned to view a building entrance, a hall leading to a bank of elevators, a teller's cage in a bank, etc. With a system that can be controlled by an attendant, a larger area can be observed. In this instance the attendant can orient the video camera from a remote location to scan a specific area. In each instance, the attendant, upon seeing a disturbance or an activity that is suspicious can immediately notify a private security guard or the local Police Department and request help.

A major disadvantage of both the fixed and controllable surveillance systems is that an individual, upon becoming aware of a disturbance or a potentially dangerous or suspicious activity, can not seize control of and focus a local surveillance camera upon him/herself or on an activity in question. With the current systems, a person who believes that he or she is in imminent danger or about to be harmed, must first contact a central office by, for example, calling 911, explain what is happening, identify the area where the activity is occurring, and wait for assistance to arrive.

Considering these drawbacks of the current systems, it is clear that a need exists for a system that can allow a person in danger to quickly seize control of a local video surveillance camera for the purpose of alerting an observing attendant that help is required and/or a recording of the occurring event should be made.

### SUMMARY OF THE INVENTION

In the method disclosed, a mobile terminal subscriber can seize control of and direct surveillance equipment to focus in on an identified area. The mobile terminal subscriber initiates the surveillance process by selecting a “surveillance” option from a menu, or by entering a code. The area placed under surveillance is the location of the subscriber's mobile terminal or a remote area identified by the subscriber. Where the area under surveillance is where the mobile terminal is located, the area can be identified by using location technology such as global satellite positioning signals or signals generated by the wireless network to obtain the coordinates of the mobile terminal. Knowing the coordinates of the area that is designated to be under surveillance and the location of the surveillance equipment (e.g., latitude, longitude and altitude), the selection and orientation of the selected surveillance equipment, i. e., a video surveillance camera located proximate the area can be oriented to focus in on the area. If desired, the subscriber can talk to an attendant observing the activity on a video consul. The area can remain under surveillance for a set time period or until terminated by the mobile terminal subscriber or the attendant. The activity under surveillance can be identified and recorded when conditions suggest that it is appropriate to do so.

### BRIEF DESCRIPTION OF THE DRAWINGS

The features, aspects and advantages of the present invention will become better understood with regard to the following description, appended claims, and accompanying drawings where:

FIG. 1 is a functional block diagram showing a network architecture for a wireless telecommunication system that can use the geographical position of a mobile terminal to control the orientation of a video surveillance camera; and

FIGS. 2 and 3 is a flowchart illustrating the process of controlling the orientation of a video surveillance camera from a mobile terminal.

### DETAILED DESCRIPTION OF THE PREFERRED EMBODIMENT

This invention relates to a video surveillance system that can be controlled by a mobile terminal subscriber to alert an attendant located at a video display that immediate assistance is required and/or a recording of observed activities is to be made. A need for this type of system is most useful where surveillance equipment can be legally deployed such as in school yards, company parking lots, bus stops, train stations, high crime areas, etc. In operation, a person located at, for example, a bus stop suddenly becomes aware that he/she is in danger and needs help. With this system the mobile terminal subscriber dials a surveillance service by, for example, pushing a single button to dial a stored phone number. Upon completion of the connection, the geographical position of the mobile terminal subscriber is automatically obtained by the surveillance service. A video surveillance camera located in the vicinity of the mobile terminal is selected. Knowing the location of the video camera and that of the mobile terminal, the orientation of the video camera can be determined. This information is transmitted to the video camera control system to orient the video camera to focus in on the mobile terminal subscriber. The mobile terminal subscriber can also place a call to an attendant by clicking a menu item (click to dial). The attendant, located at a receiving consul, sees the mobile terminal subscriber and is in a position to take appropriate action such as by asking the subscriber via the wireless telephone link what help is wanted and/or by alerting the local police dept. If desired, simultaneously, a video recording of the events as they unfold can be made for review at a later time.

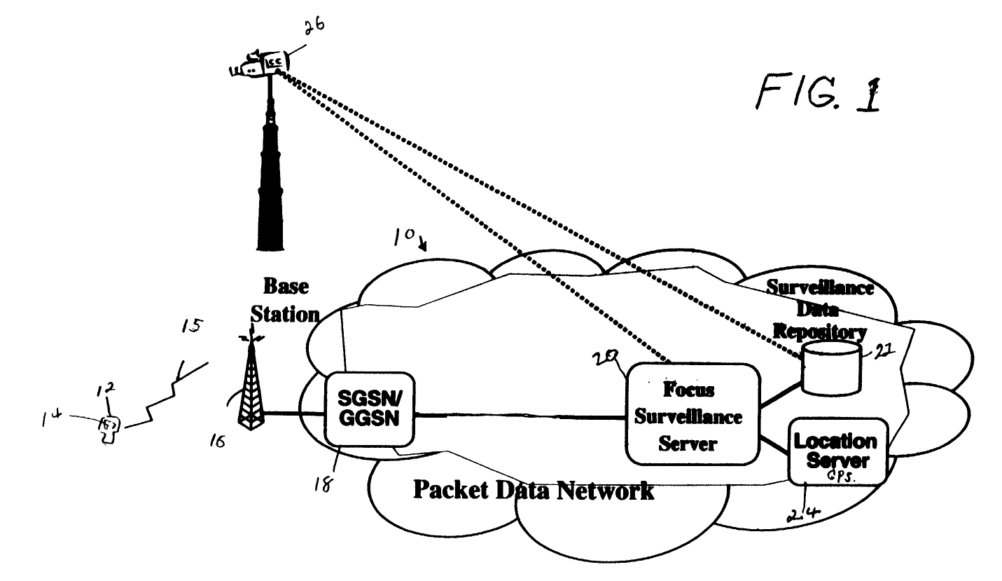

Referring to FIG. 1, there is illustrated a network architecture for a telecommunications system that can be used to provide control of a video surveillance camera in accordance with the principles of the invention. The telecommunication system 10 includes a wireless network resource group that can be implemented in a conventional wireless telephone network that has been enhanced to carry data. A wireless network capable of carrying circuit switched data can also be used for this purpose. More preferably, the wireless network resource group provides packet switched data service. An example of a wireless infrastructure includes the Universal Mobile Telephone System (UMTS), a 3^{rd} Generation wireless system based on the Global System for Mobile (GSM). GSM adds a packet network overlay known as GRPS (GSM Packet Radio Service) to a wireless circuit voice network. Thus, it is ideally suited for implementation of the wireless network resource group of FIG. 1.

Referring to the network architecture of FIG. 1, a wireless terminal 12 is assumed to include an integrated wireless transceiver for voice and data delivery, and a software controlled data terminal that include a display 14. The wireless terminal 12 is capable of displaying text messages, and may also implement a graphical user interface such as a web browser or the like. For example, the wireless terminal 12 can implement a Wireless Application Protocol (WAP) micro browser to display WAPMarkup Language (WML) documents. There are a variety of suitable wireless terminal products on the market today, and others in development. These include web enabled telephones, Personal Digital Assistants (PDA), handheld computers, pagers and the like.

In FIG. 1, the wireless terminal 12 may be roaming in a network which is owned or not owned by the provider from which services are subscribed. In that instance where the subscriber is in an area not owned by the service provider, the wireless network resource group 10 will include a visited Public Land based Mobile Network (PLMN) and a home PLMN.

The PLMN 10 includes a base station 16, a data switching node (SGSN)/a data network gateway (GGSN) 18. The base station 16 communicates over an air interface 15 with the wireless terminal 12. The data switching node/data network gateway node 18 is labeled SGSN/GGSN in FIG. 1 according to the UMTS designation for this component. Other wireless network standards may use other names. For example, the ANSI-41 standard for CDMA (Code Division Multiplex Access) data networks use the term PCF (Packet Control Function). Regardless of the implementation specific name applied, the data switching node/data network gateway node 18 is a conventional router entity with mobility support capability that routes data traffic from/to the base station 16. The data switching node/data network gateway node 18 also performs a conventional Visitor Location Register (VLR) function in terms of mobile location. The data switching node/data network gateway node are general packet radio service routers that perform General Packet Radio Service (GRPS) specific functions to handle mobility in wireless packet networks.

The SGSN/GGSN 18 is coupled to a focus surveillance server 20 which interfaces with the subscriber's mobile terminal for receiving a request to focus a video surveillance camera on an activity. The focus surveillance server 20 performs the service logic required to get the precise location of the mobile terminal subscriber from a location server; calculates the orientation of the location of the subscriber relative to the video surveillance camera; sends a request to orient the video surveillance camera based upon the calculations made; and manages the data received from the video surveillance camera for storage in a surveillance data repository 22.

The surveillance data repository 22 is coupled to receive surveillance data from the surveillance equipment 20 and store the data received in retrieval form. The data stored in the surveillance data repository 22 can be retrieved and sent to an authorized party upon request.

A video surveillance camera 24 which is remotely located from the base station is mounted to a conveniently located support structure such as a building, a lamp post, a traffic light support, etc., and is connected to the focus surveillance server 20 and the surveillance data repository 22. Data from the focus surveillance server is transmitted to and used to focus the video surveillance camera 24 to the mobile terminal's subscriber location. A video and, if appropriate, an audio recording of the activity happening in the focused location can be stored in the surveillance data repository 22 for subsequent review.

A location server 26 is connected to the focus surveillance server for receiving a request for finding the location of the mobile terminal subscriber. The location server 26 interfaces with location measurement equipment such as a mobile terminal, a global positioning service ground station and/or a global positioning service enabled mobile terminal to determine the position of a calling mobile terminal. The location server 24 sends the position information of the calling mobile terminal to the focus surveillance server 20. The focus surveillance server has the location coordinates (latitude, longitude and altitude) of the surveillance equipment stored in its memory.

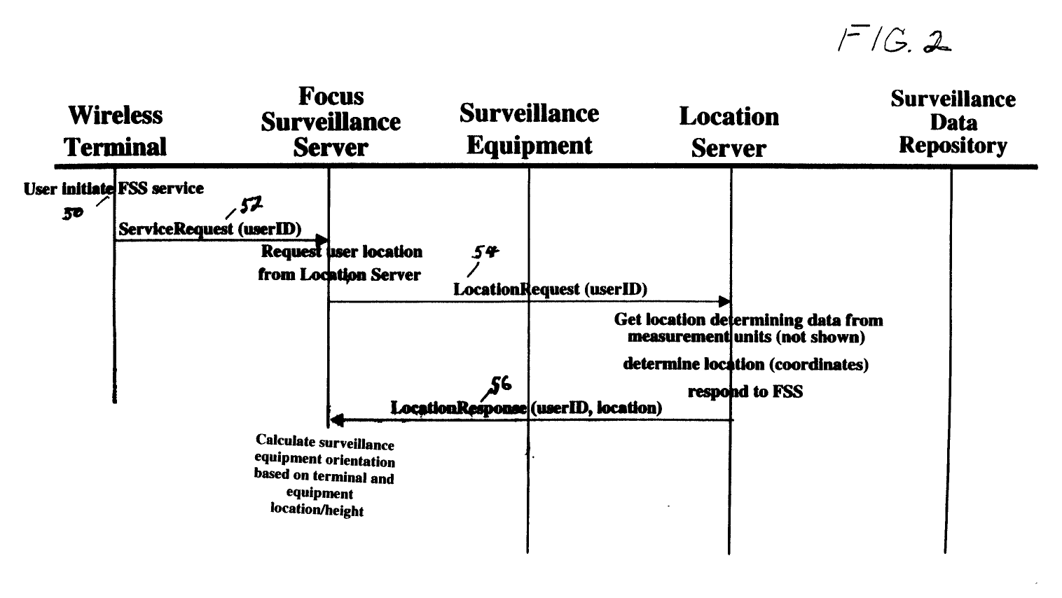

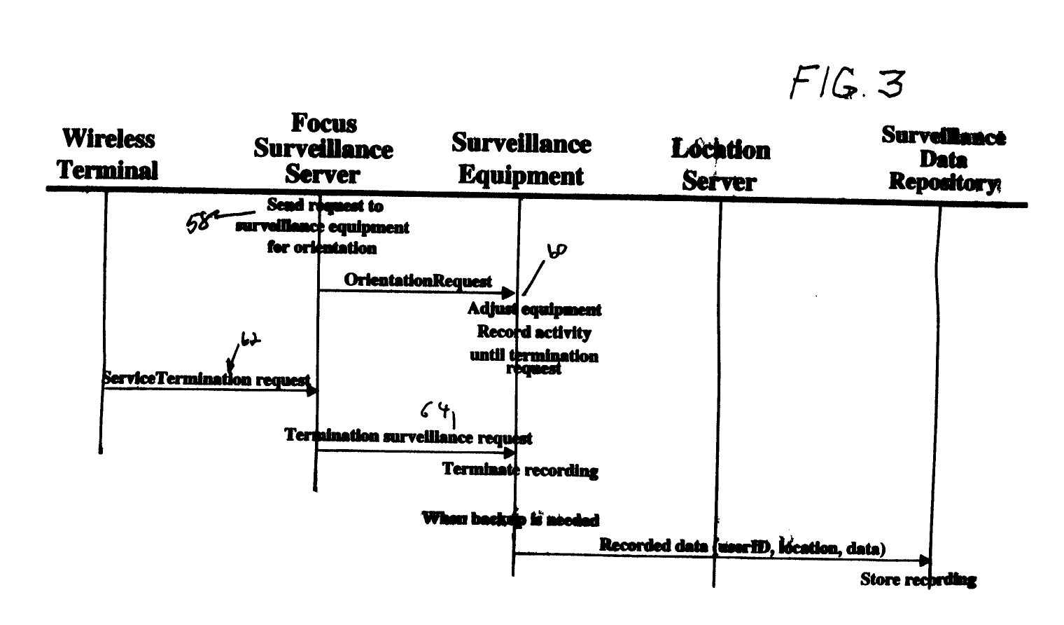

Referring to FIGS. 2 and 3, the foregoing entities of a wireless network are adapted to support a video/audio surveillance service. Prior to invoking service, the mobile terminal subscriber must obtain a service subscription and establish a user profile. Although this can be done in a variety of ways, the most likely scenario is that the subscriber signs up for the service by entering information such as name, billing address, email address, initial user service profile, etc. The subscriber will typically use a web interface for managing his/her profile or use the wireless terminal 12 to subscribe to the service and establish a profile. Alternatively, the subscriber can perform these tasks using any other suitable network device such as a personal computer or the like. The wireless terminal 12 can be programmed to provide a menu that may be presented to the user. The menu can include an entry that is named “surveillance”. Then, by depressing a single button, the service of selecting an on site or local video surveillance camera and orienting the on site or local video surveillance camera to focus in on the mobile terminal subscriber can be done rapidly and automatically. Simultaneously, the subscriber can also click on a menu item named “connect to surveillance attendant” to be connected to an attendant located at a terminal connected to received the image from the video surveillance camera and/or to a 911 operator.

By pressing a single button of a menu of services that are offered, a mobile terminal subscriber can initiate the video and/or audio surveillance service here disclosed, step 50. The subscriber's ID, step 52, is sent to the focus surveillance server 20 which sends a request, step 54, to the location server 26 to identify the location of the mobile phone. The location server sends information that identifies the location of the mobile terminal subscriber, step 56, including the subscriber's ID to the focus surveillance server. The focus surveillance server identifies and selects surveillance equipment that is local to the mobile terminal subscriber; and, based on the location of the mobile terminal and the surveillance equipment, determines what the orientation of the video surveillance camera should be to focus in on the subscriber. The focus surveillance equipment sends an orientation request to the surveillance equipment, step 58. Upon receipt of the request, step 60, the surveillance equipment is oriented to record all activity in the area of surveillance requested by the mobile terminal subscriber. The recording of the activity in the requested area continues until a termination request is generated. The termination request may be initiated by the mobile terminal subscriber; by an assistant watching the activity at a central office; or, by means of an automatic time out period. In the last mentioned instance, the equipment can be set to view a requested area for a preset interval of time, i.e., 15 minutes. After this interval it can be reoriented to focus on an activity of another mobile terminal subscriber unless specifically instructed to continue with the surveillance of the first subscriber.

When a mobile terminal subscriber wants to terminate the surveillance of an event that was requested, the subscriber either terminates the call initially made to activate the surveillance process or pushes a button on the display of the mobile terminal to terminate the on going surveillance, step 62. The request to terminate is sent to the focus surveillance server 20 which sends a termination surveillance request signal step 64, to the surveillance equipment 24 to discontinue observing the requested event. The video surveillance camera is now in condition to focus onto another event and the recording of the prior event is terminated. The event that was observed is fully identified with the necessary information such as the user ID, location, date, time etc.

While an embodiment of the invention has been described, it should be apparent that variations and alternative embodiments can be implemented in accordance with the principles of the invention. It is to be understood, therefore, that the invention is not to be in any way limited except in accordance with the spirit of the appended claims and their equivalents.

What is claimed is:

1. A method of controlling the surveillance of an area with a mobile terminal comprising the steps of;
receiving a request for surveillance from the mobile terminal,
identifying the area that is to be under surveillance, and
orienting equipment to effect surveillance of the identified area.

2. The method of claim 1 further comprising the step of:
using information from the mobile terminal to identify the area that is to be under surveillance.

3. The method of claim 1 further comprising the step of
using information from at least one base station to identify the area that is to be under surveillance.

4. The method of claim 1 further comprising the step of
using information from global positioning system ground stations to identify the area that is to by under surveillance.

5. The method of claim 2 wherein the area under surveillance is the area where the mobile terminal is located.

6. The method of claim 5 wherein the location of the mobile terminal is determined from global positioning satellite signals.

7. The method of claim 5 wherein the location of the mobile terminal is determined from the wireless network.

8. The method of claim 5 further comprising the step of using the coordinates of the location of the mobile terminal to orient a video surveillance camera to focus in on the location of the mobile terminal.

9. The method of claim 5 wherein the location of the mobile terminal relative to that of the equipment to effect surveillance is used to aim the equipment toward the mobile terminal.

10. The method of claim 5 wherein the equipment used to effect surveillance

11. The method of claim 5 wherein a person at the mobile terminal is in audio communication via the wireless network with an attendant at a video monitor.

12. The method of claim 5 wherein the equipment used to effect surveillance remains focused for a fixed interval of time.

13. The method of claim 1 further comprising making a recording of the area under surveillance.

14. The method of claim 1 wherein the request for surveillance from the mobile terminal is effected by activation a menu and selecting a surveillance option from the menu.

15. The method of claim 1 wherein the request for surveillance from the mobile terminal is effected by entering a code.

16. The method of claim 16 wherein the code comprises one or more digits.

17. The method of claim 1 further comprising the step of recording data from the active equipment effecting surveillance of the identified area.
